(19) United States
(12) Patent Application Publication
(10) Pub. No.: US 2012/0153754 A1
(43) Pub. Date: Jun. 21, 2012

(54) MOTOR PROVIDED WITH A BRAKING SYSTEM

(75) Inventors: Benoit Vincent, Champniers (FR); Pascal Beynaud, Saint Saturnin (FR)

(73) Assignee: MOTEURS LEROY-SOMER, Angouleme (FR)

(21) Appl. No.: 13/390,458

(22) PCT Filed: Aug. 26, 2010
(86) PCT No.: PCT/IB10/53849

§ 371 Date: Mar. 1, 2012

(30) Foreign Application Priority Data
Aug. 27, 2009 (FR) 09 04080

(51) Int. Cl. H02K 7/102

(52) U.S. Cl. 310/77

(57) ABSTRACT

A motor having a shaft bearing a rotor, a pulley driven by the shaft, at least one caliper brake acting on a wall turning with the pulley, and at least one axial brake.

The present invention relates to electric motors, and more particularly those provided with a braking system, in particular intended for elevators or other lifting systems.

The braking systems with which electric motors are equipped which are intended to drive elevators must meet numerous requirements both on a technical level and on a regulatory level.

They must allow reliable operation while occupying only a small amount of space, in order in particular to facilitate their installation in an elevator cage, and also be easy to manufacture and repair.

American standard ASME A17.1 relating to the design of elevator motors requires motors to include two brakes, namely a service brake and an emergency brake.

The service brake allows the elevator to be immobilized once the desired floor has been reached, when the elevator is operating normally.

The emergency brake is used when an emergency situation is detected, for example excessive upward speed or alternatively unexpected movement of the elevator, for example elevator movement while the doors thereof are not in the locked position.

The above-mentioned American standard requires the emergency brake to be able to act directly on the pulley of the electric motor, and not on the motor shaft, in order in particular to guard against any possibility of shaft breakage.

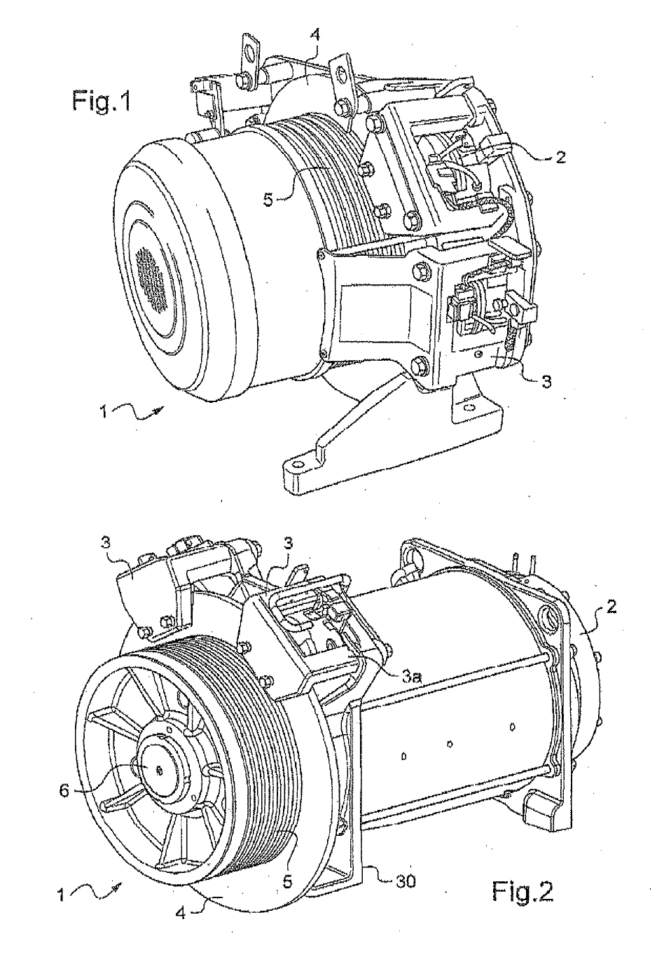

FIG. 1 shows an example of a known electric motor 1, comprising a pulley 5 integral with a peripheral brake disk 4, and two caliper brakes 2 and 3 acting on the disk 4.

One 2 of the caliper brakes is intended to serve as a service brake and the other 3 as an emergency brake.

US publication 7 116 946 discloses a motor of this type.

US application 2009/127949 discloses a motor comprising a pulley driven by the motor shaft and first and second brakes of similar structure, the first brake being combined with the pulley and the second brake being directly connected to the spindle of the motor. The first brake comprises two fluted disks mounted on an extension of the pulley and not forming an integral part thereof.

The advances achieved in suspension cables have led to a reduction in the diameter of the pulleys used, and consequently the diameter of the brake disks adjoining these pulleys.

However, reduction in diameter results in a reduction in braking torque and in order to obtain an equivalent braking torque a larger number of brakes is needed, which increases the bulk and complexity of the motor, and may hinder departure of the cables engaged on the pulley.

There is a need to reduce further the size of the drive motors while improving reliability and complying with safety standards.

The object of the invention is to meet this need and it achieves this by proposing an electrical motor comprising:
a shaft bearing a rotor,
a pulley driven by the shaft, preferably at the front of the motor,
at least one caliper brake acting on a wall turning with the pulley, for example a brake disk turning with the pulley,
at least one axial brake, preferably situated at the rear of the motor.

The caliper brake or brakes serve for example as emergency brakes and the axial brake serves for example as the service brake.

The wall to which the caliper brake(s) is(are) applied allows braking torque to be exerted on the pulley without transmission of this braking torque by the shaft. Thus, the emergency brake(s) may act directly on the pulley, which makes it possible to meet the regulatory requirements directed towards elevator electric motors.

The invention, by virtue of use of the axial brake, also means that the caliper brakes do not have to be multiplied and that a motor is provided which has a pulley of a relatively small diameter and small size, easy to install in an elevator cage.

The brake disk turning with the pulley may extend radially, the wall on which the caliper brake(s) is(are) applied preferably being in one piece with the pulley. Such an embodiment of the wall as an integral part of the pulley improves braking reliability in case of emergency and thus results in an installation providing enhanced safety over the known prior art.

The axial brake may act on a brake disk attached to the shaft.

The above-mentioned wall may have an external diameter of less than or equal to 60 cm, for example equal to 56 cm. The external diameter of the pulley is for example less than or equal to 50 cm, for example between 30 and 50 cm, being for example equal to 42 cm. The caliper brake(s) may comprise a portion projecting radially beyond the wall on which braking is exerted.

The electric motor may comprise two caliper brakes, or indeed more. The caliper brakes are preferably identical. The caliper brakes may be arranged on the brake disk turning with the pulley in a manner which may or may not be symmetrical relative to a plane. In particular, the two caliper brakes may be arranged symmetrically relative to a median plane passing through the axis of the motor. The caliper brakes may be arranged, in one exemplary embodiment, in such a way that the angular difference between them is less than or equal to 70°, the angular difference corresponding to the angle formed by the radii passing respectively through the middle of the brakes.

The arrangement of the caliper brakes at the upper part of the motor may facilitate downward departure of the cables. This particular position, when it is furthermore combined with a limited number of caliper brakes, for example one or two, makes it even more readily possible to prevent said brakes from hindering passage of the car cables.

The shaft of the motor may bear a rotor which may be of any type, with or without permanent magnets. The rotor preferably has permanent magnets. The motor may be an asynchronous or synchronous motor. The motor is preferably synchronous.

The motor may comprise more than one axial brake, for example two axial brakes arranged one behind the other.

In one exemplary embodiment, the rotor may turn between bearings, not being arranged in projecting manner.

The stator has a concentrated or distributed winding for example.

The invention may be better understood from a reading of the following detailed description of a non-limiting exemplary embodiment thereof, and from an examination of the schematic and partial figures constituting the attached drawings, in which:

FIG. 1 is a perspective view of an example of an electric motor according to the prior art,

FIG. 2 shows an example of a motor according to the invention,

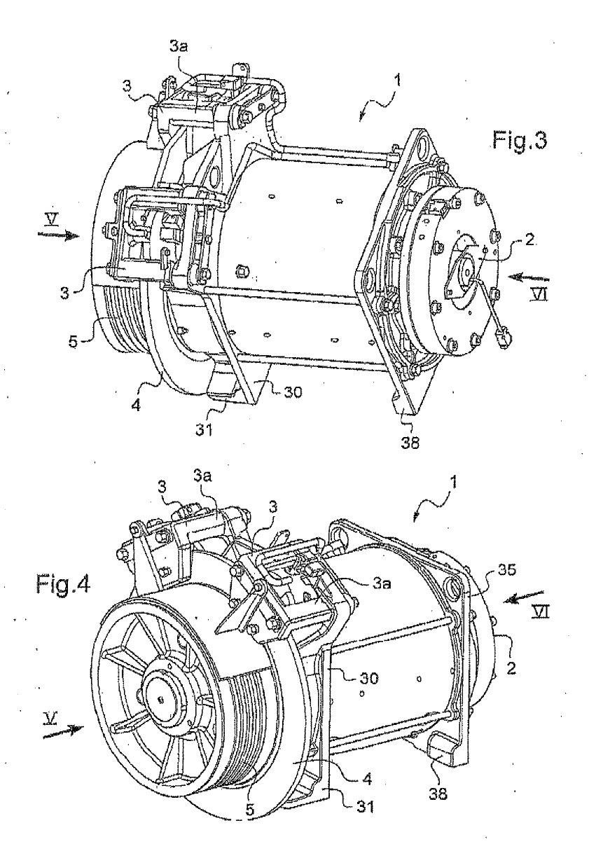

FIGS. 3 and 4 are two other perspective views of the motor of FIG. 2,

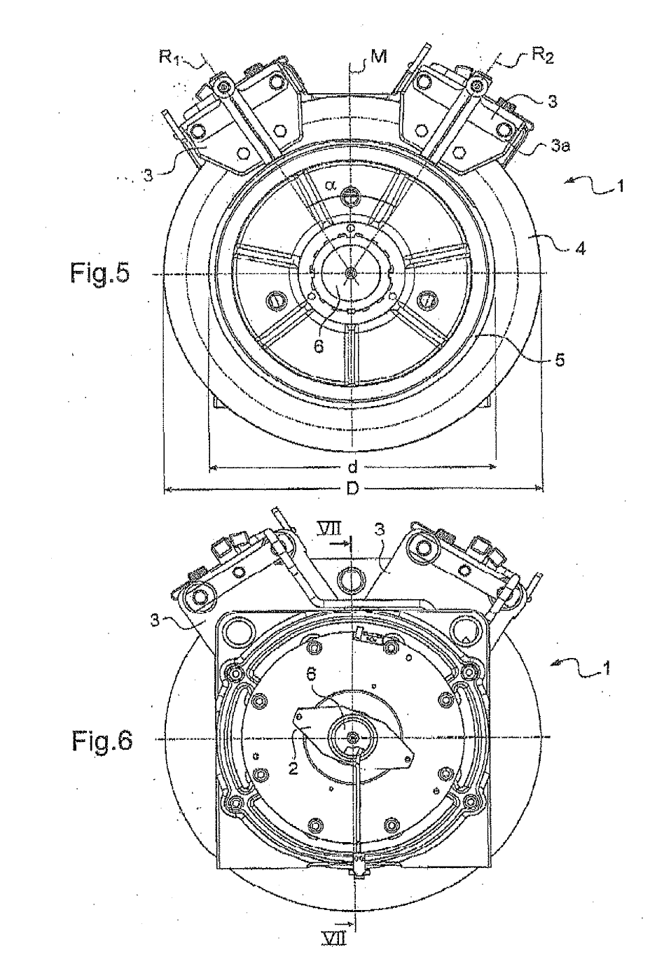

FIG. 5 is a front view, according to V in FIGS. 3 and 4, of the front of the motor,

FIG. 6 is a rear view according to VI in FIGS. 3 and 4,

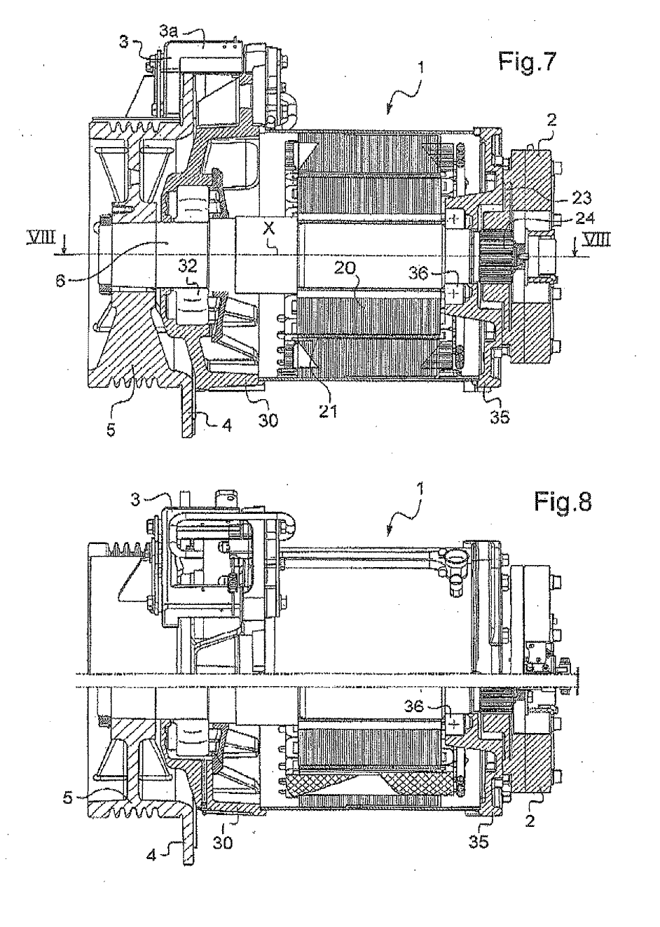

FIG. 7 is a longitudinal section according to VII-VII in FIG. 6, and

FIG. 8 is a longitudinal section according to VIII-VIII in FIG. 7.

FIG. 1 shows a motor 1 according to the invention, comprising a shaft 6 and a pulley 5 turning with the shaft 6.

The shaft 6 bears a rotor 20, visible in particular in FIG. 7, which may be of any type, in particular one having permanent magnets 21, the motor being for example a synchronous motor.

The pulley 5 is advantageously embodied, as illustrated, in one piece with a brake disk 4.

The external diameter D of the brake disk 4 is for example less than 60 cm and the external diameter d of the pulley 5 is for example less than 50 cm.

The motor 1 comprises an axial service brake 2, situated at the rear of the motor.

Opposite the service brake 2, at the front of the motor 1, there are two emergency caliper brakes 3, acting on the brake disk 4 of the pulley 5.

The emergency brakes 3 are for example arranged symmetrically relative to a median plane M of the motor 1, passing through the longitudinal axis X of the shaft 6, as may be seen in FIG. 5.

The angle a formed by the radii R₁ and R₂ of the brake disk 4 passing through the middles of the emergency brakes 3 is for example less than or equal to 70°.

A caliper brake 3 may comprise two jaws which may be applied axially to two opposing faces of the disk 4, under the action of at least one spring. At least one solenoid, when excited, allows the jaws to be separated to allow the disk to turn freely. The brake 3 comprises a part 3a which extends radially externally of the disk 4.

The caliper brakes 3 are known in themselves, for example from publications EP 0 796 814 and U.S. Pat. No. 3,964,692, and will not be described in any further detail. Caliper brakes are sold by WARNER ELECTRIC, among other manufacturers.

The axial brake 2 comprises a brake disk 23 mounted on a fluted part 24 of the shaft 6 and at least one mobile part, not shown, which is capable of being applied to the brake disk 23 under the action of at least one spring. At least one solenoid moves the mobile part away from the brake disk when powered. Axial brakes are well known in themselves, for example from publications FR 2 800 528, EP 1 622 251 or U.S. Pat. No. 7,073,641. Axial brakes are sold by WARNER ELECTRIC, among other manufacturers. The brakes described above are known as spring-loaded brakes, that is to say that braking takes place in the absence of electric power to the brakes. The opposite configuration is possible, in particular for the service brake.

An example of a motor according to the invention may have a service brake with a braking torque greater than that of each emergency brake, for example a service brake with a braking torque of 1000 Nm for an emergency braking torque of 875 Nm for each emergency brake.

The caliper brakes 3 may be borne, as illustrated, by a front flange 30 which may comprise at its base a motor fixing foot 31 and which may bear a bearing 32 for supporting the shaft 6.

The pulley 5 may be arranged on the opposite side of said flange 30 from the rotor 20. The brake disk 4 may be arranged on the side of the pulley 5 which is adjacent to the front flange 30. It may moreover, as illustrated, take the form of an integral part of the pulley 5.

The motor 1 comprises a rear flange 35 which may bear a bearing 36 and the axial brake 2 may be fixed to this flange 35 on the opposite side thereof 35 from the rotor 20, as shown.

The rear flange 35 may comprise a fixing foot 38.

The rotor 20 thus turns, in the example illustrated, between the bearings 32 and 36.

The invention is not limited to the example illustrated. For example, the caliper brakes 3 may be of the radially applied type, as disclosed in publication EP 1 796 245 A1. In this case, the wall turning with the pulley, to which the caliper brake(s) is(are) applied, in particular in the case of a wall in one piece with the pulley, may be rotationally cylindrical. In this case, the caliper brakes are also known as drum brakes.

The expression “comprising a” should be understood as being synonymous with “comprising at least one”, unless stated to the contrary.

1. A motor comprising:
a shaft bearing a rotor,
a pulley driven by the shaft,
at least one first caliper brake acting on a wall turning with the pulley, and
at least one second axial brake, wherein the wall is one piece with the pulley.

2. The motor as claimed in claim 1, the wall being formed by a disk.

3. The motor as claimed in claim 2, the disk extending radially.

4. The motor as claimed in claim 1, the shaft bearing a rotor with permanent magnets.

5. The motor as claimed in claim 1, comprising two first caliper brakes.

6. The motor as claimed in claim 5, the two first caliper brakes being arranged symmetrically relative to a median plane containing the longitudinal axis of the motor.

7. The motor as claimed in claim 5, an angular difference between the brakes being less than or equal to 70°.

8. The motor as claimed in claim 1, an external diameter of the wall being less than or equal to 60 cm.

9. The motor as claimed in claim 1, an external diameter of the pulley being less than or equal to 50 cm.

10. The motor as claimed in claim 1, the second axial brake serving as a service brake.

11. The motor as claimed in claim 1, a braking torque of the second axial brake being greater than that of a first caliper brake.

12. The motor as claimed in claim 1, the rotor turning between bearings.
